(19) United States
(12) Patent Application Publication
(10) Pub. No.: US 2005/0227101 A1
(43) Pub. Date: Oct. 13, 2005

(54) Wrapper for sandwiches and other products

(76) Inventors: Brandon C. Carpenter, Springboro, OH (US); Larry E. Teague, West Carrollton, OH (US); Jackie R. Fields, West Harrison, IN (US); Chad Clem, Hamilton, OH (US); Michael Calvin Brewster, Loveland, OH (US)

Correspondence Address: DINSMORE & SHOHL LLP;One Dayton Centre, Suite 500, One South Main Street, Dayton, OH, 45402-2023, US

(21) Appl. No.: 10/822,404

(22) Filed: Apr. 12, 2004

(51) Int. Cl. B32B 29/00; B32B 21/14

(52) U.S. Cl. 428/480; 428/535; 428/340; 428/342

(57) ABSTRACT

A laminated wrapper for a product. The laminated wrapper includes a parchment substrate, and a sheet of polyester laminated to the parchment substrate. The laminated wrapper has properties which allow the product wrapped in the laminated wrapper to be maintained in a usable condition for an extended time. The laminated wrapper can be used in an oven, microwave, refrigerator, and/or freezer. The present invention also involves a method of wrapping a product.

### BACKGROUND OF THE INVENTION

This invention relates generally to wrappers for products, and more particularly to a laminated wrapper which allows a product wrapped in it to be maintained in a usable condition for an extended time.

Many products have properties that will degrade over time. In some cases, the degradation will reduce the product's performance, while in others it can render the product useless. For example, a scented candle may lose its scent if the time between its manufacture and its subsequent sale and use by a consumer becomes too great. Other products, such as heated, moistened towels, which are often handed out to passengers after a long airplane flight, may dry out after an extended time at elevated temperature.

Still other products, such as food products having a bread or bakery component, may lose their freshness after they are heated and maintained at an elevated temperature for an extended time in an oven. The food products may be used in hot and warmer programs. In hot programs, the food product is heated to a desired temperature when the product is purchased. In warmer programs, the product is heated to a desired temperature, and then maintained at an elevated temperature for an extended time until purchased by the consumer. Food products include, but are not limited to, pizza, bread sticks, rolls, hot sandwiches, and sweet goods. Hot sandwiches include, but are not limited to, traditional sandwiches, hamburgers, hot dogs, other link sausage meats on buns, and enrobed sandwich products, such as corn dogs. Sweet goods include, but are not limited to, pastries.

If the product becomes useless because of the property degradation, it often must be thrown away. Even if the product is not thrown away, the properties may be degraded to such an extent that the price must be reduced. The price of the product will be greater than if no degradation (or less degradation) occurred because the price must include a factor to cover the cost of product waste. Thus, decreasing degradation may also reduce the cost of the product. In addition, a consumer who purchases a product having degraded properties, such as a sandwich with a bun that is not fresh, will likely view the product as undesirable and may not purchase it again.

Therefore, there is a need for a wrapper which allows a product wrapped in it to be maintained in a usable condition for an extended time.

### SUMMARY OF THE INVENTION

The present invention meets this need by providing a laminated wrapper for a product. The laminated wrapper includes a parchment substrate, and a sheet of polyester laminated to the parchment substrate. The laminated wrapper has properties which allow the product wrapped in the laminated wrapper to be maintained in a usable condition for an extended time. The laminated wrapper can be used in ovens, microwaves, refrigerators, and freezers.

Suitable parchment substrates include, but are not limited to, genuine vegetable parchment paper and parchment paper substitutes.

The parchment substrate generally has a weight of about 18 pounds to about 50 pounds per 3000 ft², typically about 20 pounds to about 27 pounds per 3000 ft².

The sheet of polyester generally has a thickness in the range of about 36 gauge to about 96 gauge, typically about 40 gauge to about 65 gauge, more typically about 40 gauge to about 55 gauge.

The sheet of polyester is adhered to the parchment substrate using adhesives including, but not limited to, heat seal adhesives, dry bond adhesives, and wet bond adhesives.

In one embodiment, the product is a food product, and the laminated wrapper has properties which allow the food product wrapped in the laminated wrapper to be maintained in an appetizing and edible form after an extended time in an oven or warmer.

Another aspect of the invention is a method of wrapping a product. The method includes providing a laminated wrapper comprising: a parchment substrate, and a sheet of polyester laminated to the parchment substrate; placing the product on the sheet of polyester; and wrapping the product in the laminated wrapper, wherein the laminated wrapper has properties which allow the product wrapped in the laminated wrapper to be maintained in a usable condition for an extended time.

### BRIEF DESCRIPTION OF THE DRAWINGS

FIG. 1 is a cross-section of one embodiment of the laminated sheet of the present invention.

### DETAILED DESCRIPTION OF THE INVENTION

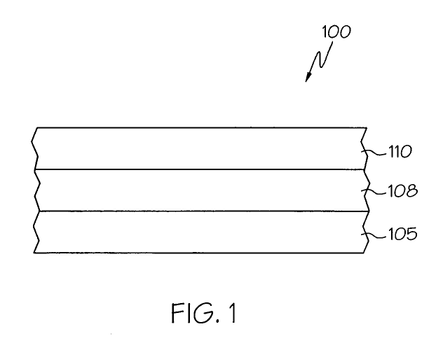

FIG. 1 shows one embodiment of the laminated wrapper 100 of the present invention. The laminated wrapper 100 has a parchment substrate 105. The parchment substrate generally has a weight of about 18 to about 50 pounds per 3000 ft², typically about 20 to about 27 pounds per 3000 ft². Suitable parchment substrates include, but are not limited to, genuine vegetable parchment paper and parchment paper substitutes. Parchment paper substitutes include, but are not limited to, greaseproof paper. The parchment substrate would not typically have any coatings on it; however, a coating could be included, if desired.

A sheet of polyester, such as polyethylene terephthalate (PET) 110 is laminated to one side of the parchment substrate 105. By polyester, we mean unsubstituted PET, substituted PET, and equivalent polyesters. The sheet of polyester generally has a thickness in the range of about 36 gauge to about 96 gauge, typically about 40 gauge to about 65 gauge, more typically about 40 gauge to about 55 gauge. The laminated wrapper 100 has properties which allow the product wrapped in the laminated wrapper to be maintained in a usable condition for an extended time.

The laminated wrapper should be heat resistant so that it does not fall apart under heat in the oven. Thus, the sheet of polyester and the adhesive used to make the laminated wrapper should not break down under heat, which would cause delamination of the wrapper. The laminated structure should also be insoluble so that it does not break down from the steam used in the warmers. In addition, the laminated structure should be grease resistant.

When a product is to be wrapped, the laminated wrapper is placed with the sheet of polyester facing the product. The product is placed on the sheet of polyester and wrapped in the laminated wrapper. The laminated wrapper has properties which allow the product wrapped in the laminated wrapper to be maintained in a usable condition for an extended time.

The laminated wrapper can be used as a flat sheet and wrapped around the product. The flat sheets can be cut from a roll of the laminated wrapper. Alternatively, the laminated wrapper can be preformed into various bag shapes, if desired. The product would then be placed into the bag, and the opening would either be folded over or sealed. The laminated wrapper also has dead fold capability which allows it to remain closed once the product is wrapped and to be reclosed if it is opened.

The laminated wrapper can be used in the automated wrapping of products as for mass production, or for hand wrapping of individual products.

Wrappers of the present invention can be used to wrap a wide variety of products which can degrade over time. Examples include, but are not limited to, scented candles, moistened towels which are to be heated, and food products.

Wrappers of the present invention can be used to wrap food products which are frozen, refrigerated, and/or heated in ovens (conventional and convection), and microwaves. Sandwiches wrapped in the wrappers of the present invention can be refrigerated for between 10 and 20 days depending on the type of sandwich while remaining in good condition. Sandwiches can be frozen for 120 to 180 days with damage to the product on heating.

Experiment 1

Different papers were evaluated. Sandwiches were assembled and hand wrapped in each type of paper. The sandwiches included: barbeque stuffed cornbread; bacon, egg, and cheese biscuit; corn dog; French toast and sausage sandwich; ham, egg, and cheese muffin; sausage gravy superstuffed biscuit; sausage, egg, and cheese bagel; sausage, egg, and cheese biscuit; and split smoked sausage.

The sandwiches were placed in a freezer. They were removed from the freezer 12 to 24 hours before testing and placed in a refrigerator so that they came to an equilibrium temperature of less than 40° F.

The sandwiches were then heated in either a microwave or an oven (conventional and convection) to achieve an internal sandwich temperature of 165° F. In a 1000 watt microwave on high power, heating times varied from 40-60 seconds, depending on the sandwich. An abuse test was also run in which the sandwich was heated for 2 to 3 minutes on high power.

Both the conventional and convection ovens were set to 300° F. Sandwiches were heated for 15-20 minutes to reach the required temperature. An abuse test was also run in which the oven was set to 350° F., and the sandwiches were heated for 15 to 20 minutes.

After the sandwiches were heated, the product and the wrapper were evaluated for integrity. The outside of the paper was observed for discoloring, burning, tearing, or any other blemish that may have developed during heating. The sandwich wrapper was then opened and evaluated for delamination. The sandwich was also reviewed for any quality issues that may have developed during heating.

After passing the initial integrity test, wrapped sandwiches were heated to the appropriate internal temperature, held in a warming oven at 160° F. and evaluated every hour for 6 hours. The sandwich was evaluated for bread quality (softness, chewiness, dryness), and the texture, flavor, quality, and dryness of the additional sandwich components. The paper was evaluated for discoloration, greasing out, wrinkling, tearing, drying, delamination, and any other quality issues that affect the consumer.

THE RESULTS ARE SHOWN IN TABLE 1.

| | Microwave | | |
|---|---|---|---|
| Paper | or Oven Safe | Paper Evaluation | Sandwich Evaluation |
| Freezer paper | Microwave | Greasing out of | Slight drying |
| | only | microwave | |
| 50# Superabsorbent | Microwave | Very greasy | |
| (no barrier) | only | | |
| Double thick wax | Microwave | Minimal greasing in | Slight drying in warmer |
| | only | warmer | |
| | | Some products stuck to | |
| | | paper when placed in | |
| | | warmer | |
| Quilon | Microwave | Semi-opaque | Products appear “wet” |
| | and oven | Retains grease but too | |
| | | transparent | |
| Grease resistant paper | Microwave | Very little greasing | Products dried out in warmer |
| | only | Off-white color | |
| Greaseproof paper | Microwave | Very little greasing | Products dried out in warmer |
| | only | More true white color | at 2 hrs. |
| Vegetable parchment | Microwave | Semi-opaque | Products dried out in warmer |
| | and oven | | |
| Freezer paper with | Microwave | Minimal greasing | Minimal drying |
| quilon liner | | In oven at 350° F., slight | |
| | | paper browning, poly | |
| | | layer melts to quilon | |
| Co-extruded PET | Microwave | No greasing in warmer | No drying in warmer |
| | and oven | Minor PET | |
| | | delamination in oven at | |
| | | 350° F. for 10 min. | |
| Laminated PET of the | Microwave | No greasing | No drying |
| present invention | and oven | PET sticks to self (not | |
| | | product) | |
| | | Paper tends to curl | |
| One sided poly | Microwave | No greasing in warmer | No drying in warmer |
| | | Slight paper browning | |
| | | in 350° F. oven | |
| | | Paper stuck to self (not | |
| | | product) in oven - | |
| | | could not open | |
| Quilt paper | Microwave | Minimal greasing | Slight drying in warmer |
| | | | Product sticking in warmer |
| | | | (bagel, cornbread, biscuit) |

Both the co-extruded PET and the laminated PET of the present invention showed no greasing, and no drying in the warmer. However, the co-extruded PET delaminated in the oven after 10 minutes at 350° F., and any delamination of the paper is unacceptable. Therefore, the co-extruded PET was not acceptable.

Experiment 2

The laminated PET wrapper of the present invention was compared to freezer paper with an inner quilon wrap. Both wrappers were used to wrap bagels, biscuits, yeast buns, muffins, and corn dogs.

The laminated PET wrapper of the present invention can be used in an oven, either conventional or convection, and in a microwave, while the freezer paper with the inner quilon wrap is microwavable only.

The laminated PET wrapper of the present invention performed significantly better than any other paper tested. After 3.5 hrs. in a warming oven, either no or minimal greasing was observed on the laminated PET wrapped products. No bread-paper sticking was observed with any of the products. Products wrapped in the laminated PET wrapper were as soft and moist as those in the freezer paper with the inner quilon wrap, with none being overly moist or soggy.

Experiment 3

The laminated PET wrappers of the present invention were evaluated by heating sandwiches in a microwave and holding them in a warmer at 160° F. for 9½ hours to analyze the quality of the products after extended heating. Three sandwiches of each type were made: barbeque stuffed cornbread; French toast and sausage; ham, egg, and cheese muffin; sausage gravy biscuit; sausage, egg, and cheese bagel; sausage, egg, and cheese biscuit; and split smoked sausage sandwich.

The bagel, muffin, cornbread, and French toast maintained excellent quality with only moderate grease transfer from the sausage to the bagel. Each of the breads was very soft and edible with little color change. All but one of the biscuits came out very soft, and the grease transfer from the sausage was not a big problem on the bottom half of the sandwich. The biscuits tended to darken more than any of the other breads, but the color was not unacceptable. The yeast biscuit used with the split smoked sausage was the only bread which was not acceptable. The top half of the sandwich acceptable, but the bottom half was not.

The two sausage gravy superstuffed biscuits maintained excellent quality throughout the day. The barbeque and sausage gravy were piping hot and quite moist. The sausage and egg patties on all of the sandwiches also remained in very good condition and quality for the entire warming period. The split smoked sausage tended to darken after holding in the warming unit and developed some unattractive wrinkling. The cheese lost some of its quality in the warming unit as moisture escaped into the bread and air. The cheese was still acceptable, but it did lose some of its meltability and reverted to a more solid state.

Experiment 4

Sixteen sandwiches (6 ham, egg, and cheese muffin (51376) and 10 split smoked sausage (51368)) were wrapped in the laminated PET wrapper of the present invention (BW) and in quilt paper of the prior art (BC) and compared for moisture loss after heating in a microwave and holding in a warming unit for a specified length of time. The sandwiches were identified so they could be tracked, and initial product weights were obtained. The sandwiches were prepared one at a time. A sandwich was taken from refrigeration (less than 40° F.) and heated in an 1800 watt microwave on high for 30 seconds. The sandwich was then transferred to the warming oven (I 60° F.) and held for 4 hours. The final weight of each sandwich was then measured, and the weight loss calculated. The results are shown in Table 2. The average weight loss from the quilt paper was 8.6 g, while the average weight loss from the laminated PET wrapper was 3.9 g. These numbers are assumed to be the moisture loss through the packaging over the holding time.

TABLE 2

| | | | | INITIAL WT | FINAL WT | | |
|---|---|---|---|---|---|---|---|
| PRODUCT | PAPER | COOKING METHOD | HOLD TIME | (g) | (g) | WT LOSS (g) | |
| 51366 | BW | 1800 Watt Microwave - 30 Sec | 4 Hours | 119.93 | 115.91 | 4.02 | |
| 51366 | BW | 1800 Watt Microwave - 30 Sec | 4 Hours | 121.14 | 118.47 | 2.67 | |
| 51366 | BW | 1800 Watt Microwave - 30 Sec | 4 Hours | 121.74 | 118.42 | 3.32 | |
| 51366 | BW | 1800 Watt Microwave - 30 Sec | 4 Hours | 123.87 | 120.05 | 3.82 | |
| 51366 | BW | 1800 Watt Microwave - 30 Sec | 4 Hours | 121.66 | 118.43 | 3.23 | |
| 51366 | BW | 1800 Watt Microwave - 30 Sec | 4 Hours | 124.33 | 121 | 3.33 | |
| 51376 | BW | 1800 Watt Microwave - 30 Sec | 4 Hours | 148.81 | 144.77 | 4.04 | |
| 51376 | BW | 1800 Watt Microwave - 30 Sec | 4 Hours | 152.5 | 146.83 | 5.67 | |
| 51376 | BW | 1800 Watt Microwave - 30 Sec | 4 Hours | 148.98 | 146.02 | 2.96 | |
| 51376 | BW | 1800 Watt Microwave - 30 Sec | 4 Hours | 148.94 | 144.84 | 4.1 | |
| 51376 | BW | 1800 Watt Microwave - 30 Sec | 4 Hours | 145.66 | 140.75 | 4.91 | |
| 51376 | BW | 1800 Watt Microwave - 30 Sec | 4 Hours | 158.49 | 155.24 | 3.25 | |
| 51376 | BW | 1800 Watt Microwave - 30 Sec | 4 Hours | 154.02 | 149.93 | 4.09 | |
| 51376 | BW | 1800 Watt Microwave - 30 Sec | 4 Hours | 161.42 | 156.89 | 4.53 | |
| 51376 | BW | 1800 Watt Microwave - 30 Sec | 4 Hours | 152.37 | 147.81 | 4.56 | AVG |
| 51376 | BW | 1800 Watt Microwave - 30 Sec | 4 Hours | 149.15 | 145.21 | 3.94 | 3.90 |
| 51366 | BC | 1800 Watt Microwave - 30 Sec | 4 Hours | 121.03 | 114.78 | 6.25 | |
| 51366 | BC | 1800 Watt Microwave - 30 Sec | 4 Hours | 120.61 | 113.9 | 6.71 | |
| 51366 | BC | 1800 Watt Microwave - 30 Sec | 4 Hours | 120.85 | 113.3 | 7.55 | |
| 51366 | BC | 1800 Watt Microwave - 30 Sec | 4 Hours | 121.23 | 115.06 | 6.17 | |
| 51366 | BC | 1800 Watt Microwave - 30 Sec | 4 Hours | 118.15 | 113.28 | 4.87 | |
| 51366 | BC | 1800 Watt Microwave - 30 Sec | 4 Hours | 118.87 | 112.86 | 6.01 | |
| 51376 | BC | 1800 Watt Microwave - 30 Sec | 4 Hours | 152.4 | 141.85 | 10.55 | |
| 51376 | BC | 1800 Watt Microwave - 30 Sec | 4 Hours | 149.28 | 139.07 | 10.21 | |
| 51376 | BC | 1800 Watt Microwave - 30 Sec | 4 Hours | 145.26 | 134.67 | 10.59 | |
| 51376 | BC | 1800 Watt Microwave - 30 Sec | 4 Hours | 145.23 | 135.86 | 9.37 | |
| 51376 | BC | 1800 Watt Microwave - 30 Sec | 4 Hours | 147.47 | 138.6 | 8.87 | |
| 51376 | BC | 1800 Watt Microwave - 30 Sec | 4 Hours | 150.12 | 138.75 | 11.37 | |
| 51376 | BC | 1800 Watt Microwave - 30 Sec | 4 Hours | 149.83 | 141.08 | 8.75 | |
| 51376 | BC | 1800 Watt Microwave - 30 Sec | 4 Hours | 146.03 | 136.85 | 9.18 | |
| 51376 | BC | 1800 Watt Microwave - 30 Sec | 4 Hours | 145.94 | 136.26 | 9.68 | AVG |
| 51376 | BC | 1800 Watt Microwave - 30 Sec | 4 Hours | 151.42 | 140.49 | 10.93 | 8.57 |

Experiment 5

The laminated PET wrapper (PET) of the present invention was compared to five different wrappers for moisture loss after heating in a microwave and holding in a warming unit for a specified length of time: parchment with one side coated with silicon (1SS), parchment with one side coated with polyethylene (1SP), vegetable parchment (VEG), double thick wax paper (WAX), quilon treated kraft or greaseproof paper for a bacon tray liner (BTL).

Four types of sandwiches were wrapped in the different wrappers: sausage, egg, and cheese bagel (51372); bacon, egg, and cheese biscuit (51362); French toast and sausage sandwich (51366); and ham, egg, and cheese muffin (51368). Labels were applied to the front and back of the sandwich. The sandwiches were identified for tracking purposes, and the initial weight recorded.

Each sandwich was heated from refrigeration (less than 40° F.) in an 1800 watt microwave on high for 30 seconds. The sandwich was then transferred to the warming oven (160° F.) and held for 4 hours. The final weight of each sandwich was then measured, and the weight loss calculated.

The results are shown in Table 3. The average weight loss for the parchment with one side coated with silicon was 16.6 g, for the parchment with one side coated with poly was 7.1 g, for the vegetable parchment was 14.6 g, for the double thick wax paper was 14.8 g, for the bacon tray liner was 16.5 g, and for the laminated PET wrapper was 3.7 g.

The sandwiches in the wax paper, the vegetable parchment, the parchment with one side coated with silicon, and the bacon tray liner were noticeably dry after holding for 4 hours in the warming unit. The breads of these sandwiches were significantly harder and less pliable than the breads in either the laminated PET wrapper or the parchment with one side coated with poly. The vegetable parchment, the parchment with one side coated with silicon, the bacon tray liner, and the parchment with one side coated with poly were much more transparent than either the laminated PET wrapper or the wax paper, especially where the meat or cheese came into contact with the paper's surface. These papers appeared “wet” and “greasy” in those locations, which is less acceptable to consumers. In addition, the wax paper stuck to the products upon opening, and the parchment with one side coated with poly turned brown after holding in the warming unit for 4 hours.

TABLE 3

| | | | | INITIAL WT | FINAL WT | | |
|---|---|---|---|---|---|---|---|
| PRODUCT | PAPER | COOKING METHOD | HOLD TIME | (g) | (g) | WT LOSS (g) | |
| 51372 | VEG | 1800 Watt Microwave - 30 Sec | 4 Hours | 159.05 | 146.26 | 12.79 | |
| 51372 | VEG | 1800 Watt Microwave - 30 Sec | 4 Hours | 156.78 | 141.32 | 15.46 | |
| 51372 | VEG | 1800 Watt Microwave - 30 Sec | 4 Hours | 163.51 | 151.59 | 11.92 | |
| 51372 | VEG | 1800 Watt Microwave - 30 Sec | 4 Hours | 158.49 | 142.41 | 16.08 | |
| 51372 | VEG | 1800 Watt Microwave - 30 Sec | 4 Hours | 159.87 | 146.18 | 13.69 | |
| 51372 | VEG | 1800 Watt Microwave - 30 Sec | 4 Hours | 161.79 | 148.3 | 13.49 | |
| 51368 | VEG | 1800 Watt Microwave - 30 Sec | 4 Hours | 118.21 | 102.22 | 15.99 | |
| 51368 | VEG | 1800 Watt Microwave - 30 Sec | 4 Hours | 113.35 | 97.36 | 15.99 | |
| 51368 | VEG | 1800 Watt Microwave - 30 Sec | 4 Hours | 117.75 | 100.95 | 16.8 | |
| 51368 | VEG | 1800 Watt Microwave - 30 Sec | 4 Hours | 116.81 | 100.6 | 16.21 | |
| 51368 | VEG | 1800 Watt Microwave - 30 Sec | 4 Hours | 116.05 | 99.99 | 16.06 | |
| 51368 | VEG | 1800 Watt Microwave - 30 Sec | 4 Hours | 113.17 | 101.29 | 11.88 | |
| 51366 | VEG | 1800 Watt Microwave - 30 Sec | 4 Hours | 132.78 | 119.45 | 13.33 | |
| 51366 | VEG | 1800 Watt Microwave - 30 Sec | 4 Hours | 119.09 | 105.34 | 13.75 | |
| 51366 | VEG | 1800 Watt Microwave - 30 Sec | 4 Hours | 127.73 | 114.15 | 13.58 | |
| 51366 | VEG | 1800 Watt Microwave - 30 Sec | 4 Hours | 132.65 | 119.26 | 13.39 | |
| 51366 | VEG | 1800 Watt Microwave - 30 Sec | 4 Hours | 121.45 | 106.35 | 15.1 | AVG |
| 51366 | VEG | 1800 Watt Microwave - 30 Sec | 4 Hours | 125.6 | 108.83 | 16.77 | 14.57 |
| 51372 | 1SS | 1800 Watt Microwave - 30 Sec | 4 Hours | 160.12 | 149.13 | 10.99 | |
| 51372 | 1SS | 1800 Watt Microwave - 30 Sec | 4 Hours | 164.3 | 151.84 | 12.46 | |
| 51372 | 1SS | 1800 Watt Microwave - 30 Sec | 4 Hours | 161.21 | 149.11 | 12.1 | |
| 51372 | 1SS | 1800 Watt Microwave - 30 Sec | 4 Hours | 160.91 | 150.58 | 10.33 | |
| 51372 | 1SS | 1800 Watt Microwave - 30 Sec | 4 Hours | 156.32 | 143.2 | 13.12 | |
| 51372 | 1SS | 1800 Watt Microwave - 30 Sec | 4 Hours | 163.58 | 150.25 | 13.33 | |
| 51366 | 1SS | 1800 Watt Microwave - 30 Sec | 4 Hours | 116.14 | 96.24 | 19.9 | |
| 51366 | 1SS | 1800 Watt Microwave - 30 Sec | 4 Hours | 106.5 | 88.7 | 17.8 | |
| 51366 | 1SS | 1800 Watt Microwave - 30 Sec | 4 Hours | 107.47 | 88.86 | 18.61 | |
| 51366 | 1SS | 1800 Watt Microwave - 30 Sec | 4 Hours | 120.58 | 98.08 | 22.5 | |
| 51366 | 1SS | 1800 Watt Microwave - 30 Sec | 4 Hours | 114.28 | 96 | 18.28 | |
| 51366 | 1SS | 1800 Watt Microwave - 30 Sec | 4 Hours | 115.15 | 94.01 | 21.14 | |
| 51362 | 1SS | 1800 Watt Microwave - 30 Sec | 4 Hours | 113.56 | 97.85 | 15.71 | |
| 51362 | 1SS | 1800 Watt Microwave - 30 Sec | 4 Hours | 109.6 | 93.52 | 16.08 | |
| 51368 | 1SS | 1800 Watt Microwave - 30 Sec | 4 Hours | 114.97 | 96.72 | 18.25 | |
| 51368 | 1SS | 1800 Watt Microwave - 30 Sec | 4 Hours | 118.28 | 99.4 | 18.88 | |
| 51368 | 1SS | 1800 Watt Microwave - 30 Sec | 4 Hours | 116.99 | 98.14 | 18.85 | |
| 51368 | 1SS | 1800 Watt Microwave - 30 Sec | 4 Hours | 117.14 | 100.08 | 17.06 | |
| 51368 | 1SS | 1800 Watt Microwave - 30 Sec | 4 Hours | 116.85 | 98.39 | 18.46 | AVG |
| 51368 | 1SS | 1800 Watt Microwave - 30 Sec | 4 Hours | 116.26 | 97.63 | 18.63 | 16.62 |
| 51366 | WAX | 1800 Watt Microwave - 30 Sec | 4 Hours | 124.2 | 107.29 | 16.91 | |
| 51366 | WAX | 1800 Watt Microwave - 30 Sec | 4 Hours | 113.15 | 92.43 | 20.72 | |
| 51366 | WAX | 1800 Watt Microwave - 30 Sec | 4 Hours | 119.21 | 102.89 | 16.32 | |
| 51366 | WAX | 1800 Watt Microwave - 30 Sec | 4 Hours | 118.53 | 98.13 | 20.4 | |
| 51366 | WAX | 1800 Watt Microwave - 30 Sec | 4 Hours | 117.08 | 99.21 | 17.87 | |
| 51366 | WAX | 1800 Watt Microwave - 30 Sec | 4 Hours | 117.56 | 98.27 | 19.29 | |
| 51368 | WAX | 1800 Watt Microwave - 30 Sec | 4 Hours | 120.21 | 105.27 | 14.94 | |
| 51368 | WAX | 1800 Watt Microwave - 30 Sec | 4 Hours | 120.05 | 104.88 | 15.17 | |
| 51368 | WAX | 1800 Watt Microwave - 30 Sec | 4 Hours | 109.95 | 93.71 | 16.24 | |
| 51368 | WAX | 1800 Watt Microwave - 30 Sec | 4 Hours | 123.89 | 110.63 | 13.26 | |
| 51368 | WAX | 1800 Watt Microwave - 30 Sec | 4 Hours | 118.51 | 103.05 | 15.46 | |
| 51368 | WAX | 1800 Watt Microwave - 30 Sec | 4 Hours | 120.26 | 105.17 | 15.09 | |
| 51372 | WAX | 1800 Watt Microwave - 30 Sec | 4 Hours | 161.24 | 149.37 | 11.87 | |
| 51372 | WAX | 1800 Watt Microwave - 30 Sec | 4 Hours | 165.12 | 155.43 | 9.69 | |
| 51372 | WAX | 1800 Watt Microwave - 30 Sec | 4 Hours | 160.21 | 148.86 | 11.35 | |
| 51372 | WAX | 1800 Watt Microwave - 30 Sec | 4 Hours | 159.69 | 147.71 | 11.98 | |
| 51372 | WAX | 1800 Watt Microwave - 30 Sec | 4 Hours | 164.46 | 152.02 | 12.44 | |
| 51372 | WAX | 1800 Watt Microwave - 30 Sec | 4 Hours | 161.17 | 149.38 | 11.79 | |
| 51362 | WAX | 1800 Watt Microwave - 30 Sec | 4 Hours | 120.29 | 107.42 | 12.87 | AVG |
| 51362 | WAX | 1800 Watt Microwave - 30 Sec | 4 Hours | 113.7 | 102.45 | 11.25 | 14.75 |
| 51368 | BTL | 1800 Watt Microwave - 30 Sec | 4 Hours | 118.66 | 105.4 | 13.26 | |
| 51368 | BTL | 1800 Watt Microwave - 30 Sec | 4 Hours | 120.52 | 105.6 | 14.92 | |
| 51368 | BTL | 1800 Watt Microwave - 30 Sec | 4 Hours | 124.94 | 110.12 | 14.82 | |
| 51368 | BTL | 1800 Watt Microwave - 30 Sec | 4 Hours | 114.64 | 100.42 | 14.22 | |
| 51368 | BTL | 1800 Watt Microwave - 30 Sec | 4 Hours | 117.8 | 102.62 | 15.18 | |
| 51368 | BTL | 1800 Watt Microwave - 30 Sec | 4 Hours | 121.33 | 108.57 | 12.76 | |
| 51372 | BTL | 1800 Watt Microwave - 30 Sec | 4 Hours | 160.25 | 149.43 | 10.82 | |
| 51372 | BTL | 1800 Watt Microwave - 30 Sec | 4 Hours | 158.41 | 146 | 12.41 | |
| 51372 | BTL | 1800 Watt Microwave - 30 Sec | 4 Hours | 157.87 | 144.03 | 13.84 | |
| 51372 | BTL | 1800 Watt Microwave - 30 Sec | 4 Hours | 160.85 | 146.13 | 14.72 | |
| 51372 | BTL | 1800 Watt Microwave - 30 Sec | 4 Hours | 145.41 | 130.65 | 14.76 | |
| 51372 | BTL | 1800 Watt Microwave - 30 Sec | 4 Hours | 158.44 | 140.13 | 18.31 | |
| 51366 | BTL | 1800 Watt Microwave - 30 Sec | 4 Hours | 118.33 | 95.3 | 23.03 | |
| 51366 | BTL | 1800 Watt Microwave - 30 Sec | 4 Hours | 123.14 | 100.62 | 22.52 | |
| 51366 | BTL | 1800 Watt Microwave - 30 Sec | 4 Hours | 118.04 | 97.38 | 20.66 | |
| 51366 | BTL | 1800 Watt Microwave - 30 Sec | 4 Hours | 115.54 | 94.42 | 21.12 | |
| 51366 | BTL | 1800 Watt Microwave - 30 Sec | 4 Hours | 122.83 | 103.05 | 19.78 | |
| 51366 | BTL | 1800 Watt Microwave - 30 Sec | 4 Hours | 117.92 | 97.36 | 20.56 | |
| 51362 | BTL | 1800 Watt Microwave - 30 Sec | 4 Hours | 114.73 | 99.35 | 15.38 | AVG |
| 51362 | BTL | 1800 Watt Microwave - 30 Sec | 4 Hours | 108.49 | 91.85 | 16.64 | 16.49 |
| 51372 | PET | 1800 Watt Microwave - 30 Sec | 4 Hours | 166.04 | 163.83 | 2.21 | |
| 51372 | PET | 1800 Watt Microwave - 30 Sec | 4 Hours | 155.64 | 152.93 | 2.71 | |
| 51372 | PET | 1800 Watt Microwave - 30 Sec | 4 Hours | 163.94 | 161.01 | 2.93 | |
| 51372 | PET | 1800 Watt Microwave - 30 Sec | 4 Hours | 159.52 | 157.02 | 2.5 | |
| 51372 | PET | 1800 Watt Microwave - 30 Sec | 4 Hours | 165.69 | 162.75 | 2.94 | |
| 51372 | PET | 1800 Watt Microwave - 30 Sec | 4 Hours | 161.08 | 158.6 | 2.48 | |
| 51366 | PET | 1800 Watt Microwave - 30 Sec | 4 Hours | 121.26 | 117 | 4.26 | |
| 51366 | PET | 1800 Watt Microwave - 30 Sec | 4 Hours | 119.1 | 114.74 | 4.36 | |
| 51366 | PET | 1800 Watt Microwave - 30 Sec | 4 Hours | 113.64 | 109.28 | 4.36 | |
| 51366 | PET | 1800 Watt Microwave - 30 Sec | 4 Hours | 122.81 | 118.76 | 4.05 | |
| 51366 | PET | 1800 Watt Microwave - 30 Sec | 4 Hours | 117.26 | 112.91 | 4.35 | |
| 51366 | PET | 1800 Watt Microwave - 30 Sec | 4 Hours | 124.63 | 119.99 | 4.64 | |
| 51362 | PET | 1800 Watt Microwave - 30 Sec | 4 Hours | 121.17 | 114.96 | 6.21 | AVG |
| 51362 | PET | 1800 Watt Microwave - 30 Sec | 4 Hours | 112.7 | 108.45 | 4.25 | 3.73 |
| 51372 | 1SP | 1800 Watt Microwave - 30 Sec | 4 Hours | 168.57 | 164.5 | 4.07 | |
| 51372 | 1SP | 1800 Watt Microwave - 30 Sec | 4 Hours | 168 | 161.81 | 6.19 | |
| 51372 | 1SP | 1800 Watt Microwave - 30 Sec | 4 Hours | 169.11 | 163.34 | 5.77 | |
| 51372 | 1SP | 1800 Watt Microwave - 30 Sec | 4 Hours | 161.49 | 157.36 | 4.13 | |
| 51372 | 1SP | 1800 Watt Microwave - 30 Sec | 4 Hours | 163.73 | 157.5 | 6.23 | |
| 51372 | 1SP | 1800 Watt Microwave - 30 Sec | 4 Hours | 165.39 | 160.49 | 4.9 | |
| 51362 | 1SP | 1800 Watt Microwave - 30 Sec | 4 Hours | 115.66 | 107.56 | 8.1 | |
| 51362 | 1SP | 1800 Watt Microwave - 30 Sec | 4 Hours | 114.5 | 107.3 | 7.2 | |
| 51366 | 1SP | 1800 Watt Microwave - 30 Sec | 4 Hours | 119.13 | 108.89 | 10.24 | |
| 51366 | 1SP | 1800 Watt Microwave - 30 Sec | 4 Hours | 117.29 | 109.74 | 7.55 | |
| 51366 | 1SP | 1800 Watt Microwave - 30 Sec | 4 Hours | 121.87 | 114.16 | 7.71 | |
| 51366 | 1SP | 1800 Watt Microwave - 30 Sec | 4 Hours | 120.34 | 107.6 | 12.74 | |
| 51366 | 1SP | 1800 Watt Microwave - 30 Sec | 4 Hours | 119.73 | 112.71 | 7.02 | AVG |
| 51366 | 1SP | 1800 Watt Microwave - 30 Sec | 4 Hours | 104.64 | 96.78 | 7.86 | 7.12 |

With food products, the water vapor transmission rate of the laminated wrapper is sufficient to allow moisture to escape through the laminated wrapper so that the food product wrapped in the laminated wrapper is maintained in an appetizing and edible form after an extended time in an oven. The laminated wrapper can be used in convection ovens, microwave ovens, and traditional ovens. The laminated wrapper has properties which allow the food product wrapped in the laminated wrapper to be maintained in an appetizing and edible form for up to 8 hours in an oven, typically about 2 to about 6 hours, while maintaining the freshness of the bread. For example, the freshness of the bread in a food product was maintained after it was heated for about 10 to about 20 minutes at 350° F. and placed in a warmer for up to 6 hours at 165° F. In contrast, under similar conditions, parchment paper with a coextruded polyester layer maintained the freshness of the bread for only 30 minutes, and a cellophane product broke down.

While certain representative embodiments and details have been shown for purposes of illustrating the invention, it will be apparent to those skilled in the art that various changes in the compositions and methods disclosed herein may be made without departing from the scope of the invention, which is defined in the appended claims.

1. A laminated wrapper for a product comprising:
a parchment substrate; and
a sheet of polyester laminated to the parchment substrate,
wherein the laminated wrapper has properties which allow the product wrapped in the laminated wrapper to be maintained in a usable condition for an extended time.

2. The laminated wrapper of claim 1 wherein the parchment substrate is selected from genuine vegetable parchment paper and parchment paper substitutes.

3. The laminated wrapper of claim 1 wherein the parchment substrate has a weight of about 18 pounds to about 50 pounds per 3000 ft².

4. The laminated wrapper of claim 1 wherein the parchment substrate has a weight of about 20 pounds to about 27 pounds per 3000 ft².

5. The laminated wrapper of claim 1 wherein the sheet of polyester has a thickness in a range of about 36 gauge to about 96 gauge.

6. The laminated wrapper of claim 1 wherein the sheet of polyester has a thickness in a range of about 40 gauge to about 65 gauge.

7. The laminated wrapper of claim 1 wherein the product is a food product and wherein the laminated wrapper has properties which allow the food product wrapped in the laminated wrapper to be maintained in an appetizing and edible form after an extended time in an oven.

8. The laminated wrapper of claim 7 wherein the laminated wrapper has properties which allow the food product wrapped in the laminated wrapper to be maintained in an appetizing and edible form for up to 8 hours in the oven.

9. The laminated wrapper of claim 7 wherein the laminated wrapper has properties which allow the food product wrapped in the laminated wrapper to be maintained in an appetizing and edible form after heating for about 10 to about 20 minutes at 350° F. and up to 6 hours at 165° F.

10. The laminated wrapper of claim 1 wherein the product is a food product and wherein the laminated wrapper has properties which allow the food product wrapped in the laminated wrapper to be maintained in an appetizing and edible form after an extended time in a refrigerator.

11. The laminated wrapper of claim 10 wherein the laminated wrapper has properties which allow the food product wrapped in the laminated wrapper to be maintained in an appetizing and edible form for at least 10 days in the refrigerator.

12. The laminated wrapper of claim 1 wherein the product is a food product and wherein the laminated wrapper has properties which allow the food product wrapped in the laminated wrapper to be maintained in an appetizing and edible form after an extended time in a freezer.

13. The laminated wrapper of claim 12 wherein the laminated wrapper has properties which allow the food product wrapped in the laminated wrapper to be maintained in an appetizing and edible form for at least 120 days in the freezer.

14. The laminated wrapper of claim 1 wherein the sheet of polyester is laminated to the parchment substrate using an adhesive selected from heat seal adhesives, dry bond adhesives, and wet bond adhesives.

15. A method of wrapping a product comprising:
providing a laminated wrapper comprising:
a parchment substrate; and
a sheet of polyester laminated to the parchment substrate;
placing the product on the sheet of polyester; and
wrapping the product in the laminated wrapper;
wherein the laminated wrapper has properties which allow the product wrapped in the laminated wrapper to be maintained in a usable condition for an extended time.

16. The method of claim 15 wherein the parchment substrate is selected from genuine vegetable parchment paper and parchment paper substitutes.

17. The method of claim 15 wherein the parchment substrate has a weight of about 18 pounds to about 50 pounds per 3000 ft².

18. The method of claim 15 wherein the parchment substrate has a weight of about 20 pounds to about 27 pounds per 3000 ft².

19. The method of claim 15 wherein the sheet of polyester has a thickness in a range of about 36 gauge to about 96 gauge.

20. The method of claim 15 wherein the sheet of polyester has a thickness in a range of about 40 gauge to about 65 gauge.

21. The method of claim 15 wherein the product is a food product and further comprising placing the food product wrapped in the laminated wrapper in an oven, wherein the laminated wrapper has properties which allow the food product wrapped in the laminated wrapper to be maintained in an appetizing and edible form after an extended time in the oven.

22. The method of claim 21 wherein the food product wrapped in the laminated wrapper is placed in the oven for up to 8 hours.

23. The method of claim 21 wherein the food product wrapped in the laminated wrapper is placed in the oven for about 10 to about 20 minutes at 350° F. and up to 6 hours at 165° F.

24. The method of claim 21 wherein the food product is heated in a microwave before being placed in the oven.

25. The method of claim 15 wherein the product is a food product and further comprising placing the food product wrapped in the laminated wrapper in a refrigerator, wherein the laminated wrapper has properties which allow the food product wrapped in the laminated wrapper to be maintained in an appetizing and edible form after an extended time in the refrigerator.

26. The method of claim 25 wherein the food product wrapped in the laminated wrapper is placed in the refrigerator for at least 10 days.

27. The method of claim 15 wherein the product is a food product and further comprising placing the food product wrapped in the laminated wrapper in a freezer, wherein the laminated wrapper has properties which allow the food product wrapped in the laminated wrapper to be maintained in an appetizing and edible form after an extended time in the freezer.

28. The method of claim 27 wherein the food product wrapped in the laminated wrapper is placed in the freezer for at least 120 days.

29. The method of claim 15 wherein the sheet of polyester is laminated to the parchment substrate using an adhesive selected from heat seal adhesives, dry bond adhesives, and wet bond adhesives.

30. The laminated wrapper of claim 7 wherein the food product wrapped in the laminated wrapper has a weight loss of less than 10 g after heating in an oven for 4 hours at 160° F.

31. The laminated wrapper of claim 7 wherein the food product wrapped in the laminated wrapper has a weight loss of less than 5 g after heating in an oven for 4 hours at 160° F.

32. The laminated wrapper of claim 7 wherein the food product wrapped in the laminated wrapper has a weight loss of less than 4 g after heating in an oven for 4 hours at 160° F.

33. The method of claim 21 wherein the food product wrapped in the laminated wrapper has a weight loss of less than 10 g after heating in an oven for 4 hours at 160° F.

34. The method of claim 21 wherein the food product wrapped in the laminated wrapper has a weight loss of less than 5 g after heating in an oven for 4 hours.

35. The method of claim 21 wherein the food product wrapped in the laminated wrapper has a weight loss of less than 4 g after heating in an oven for 4 hours.
